(19) United States
(12) Patent Application Publication
(10) Pub. No.: US 2017/0002987 A1
(43) Pub. Date: Jan. 5, 2017

(54) LED LIGHTING DEVICE

(71) Applicant: Ushio Denki Kabushiki Kaisha, Tokyo (JP)

(72) Inventors: Go TAKAHASHI, Tokyo (JP); Takeshi MURAKAMI, Tokyo (JP)

(73) Assignee: Ushio Denki Kabushiki Kaisha, Tokyo (JP)

(21) Appl. No.: 15/200,502

(22) Filed: Jul. 1, 2016

(30) Foreign Application Priority Data
Jul. 3, 2015 (JP) 2015-134123

(51) Int. Cl. F21K 9/60; F21V 23/04; F21V 23/00

(52) U.S. Cl. CPC F21K 9/60; F21V 23/003; F21V 23/04; F21Y 2115/10

(57) ABSTRACT

An LED lighting device which can emit light in a wide range of color temperatures and provides favorable color mixing of the emitted mixed color light on an irradiated surface. The LED lighting device includes a (a≧3) red LEDs, b (b≧2) green LEDs, c (c≧3) blue LEDs and d (d≧1) lime LED(s) that are arranged in an arrangement region on a substrate, and a control mechanism that performs operation control on the LEDs of each color, wherein conditions (1) b≦a, (2) b≦c and (3) 0.1 (a+c)≦d≦0.28 (a+c) are satisfied, and at least one or more of LEDs arranged to adjoin each lime LED is/are any of the red LEDs or any of the blue LEDs.

### TECHNICAL FIELD

The present invention relates to an LED lighting device that uses a plurality of red LEDs, blue LEDs, green LEDs and lime LEDs as light sources, and can emit mixed color light of intended color temperature.

### BACKGROUND ART

An LED lighting device using a red LED, a green LED and a blue LED, which emit light corresponding to three primary colors of light, as light sources has been known heretofore (for example, see Patent Literature 1).

Specifically, such an LED lighting device changes the color temperature of mixed color light emitted as a whole by selecting whether to turn on or off the LED of each color or by changing the output of the LEDs color by color to change brightness.

For example, to increase the color temperature of light from candle light (approximately 2500 K) to incandescent bulb light (approximately 3000 K), the output of the light emitted from the green LED is increased.

The output of the light emitted from the green LED is also increased, for example, to increase the color temperature of light from light bulb color light (approximately 3800 K) to light of a white fluorescent lamp (approximately 4100 K).

For example, to lower the color temperature of light from light of a daylight color fluorescent lamp (approximately 6200 K) to light of a three-wavelength natural white fluorescent lamp (approximately 5200 K), the output of the light emitted from the blue LED is decreased.

If a white color adjustment is performed by using only the light sources for emitting light of three primary colors, which are the red, green and blue LEDs, the possible range of color temperatures of the mixed color light emitted is not wide.

### CITATION LIST

### Patent Literature

Patent Literature 1: Japanese Patent Application Laid-Open No. 2003-151783

### SUMMARY OF INVENTION

### Technical Problem

To solve the foregoing problem, an additional lime LED can be used in addition to the red, green and blue LEDs to widen the range of color temperatures in which mixed color light can be emitted. However, the emitted mixed color light often produces color unevenness on the irradiated surface.

The present invention has been made in view of the foregoing circumstances and has as its object the provision of an LED lighting device which can emit light in a wide range of color temperatures and provides favorable color mixing of the emitted mixed color light on an irradiated surface.

### Means for Solving the Problem

According to the present invention, there is provided an LED lighting device including a (a≧3) red LEDs, b (b≧2) green LEDs, c (c≧3) blue LEDs and d (d≧1) lime LED(s) that are arranged in an arrangement region on a substrate, and a control mechanism that performs operation control on the LEDs of each color, wherein

the following conditions (1) to (3):

b≦a (1)

b≦c and (2)

0.1(a+c)≦d≦0.28(a+c) (3)

are satisfied, and

at least one or more of the LEDs arranged to adjoin each lime LED is/are any of the red LEDs or any of the blue LEDs.

The LED lighting device according to the present invention may be configured so that the red LEDs emit light having a peak wavelength within a range of 620 to 645 nm,

the green LEDs emit light having a peak wavelength within a range of 520 to 540 nm,

the blue LEDs emit light having a peak wavelength within a range of 460 to 480 nm, and

the lime LED(s) emits/emit light having a peak wavelength within a range of 566 to 569 nm.

In the LED lighting device according to the present invention, an LED arranged to adjoin each green LED may preferably be any of the red LEDs or any of the blue LEDs.

### Advantageous Effects of Invention

The LED lighting device according to the present invention includes respective relatively-specified numbers of red LEDs, green LEDs, blue LEDs and lime LEDs. Mixed color light in a wide range of color temperatures can thus be emitted by simply performing operation control on the LEDs of each color.

In the LED lighting device according to the present invention, at least one or more of the LEDs arranged to adjoin each lime LED is/are any of the red LEDs or any of the blue LEDs. The lime LED has a light emission efficiency higher than that of the red LED and the blue LED. Such an arrangement of the LEDs therefore increases the uniformity of the light intensity in the entire arrangement region of the substrate. This results in favorable color mixing of the emitted mixed color light on an irradiated surface.

### BRIEF DESCRIPTION OF DRAWINGS

FIG. 1 is a schematic diagram illustrating an arrangement state of LEDs of respective colors according to an example of an LED lighting device of the present invention.

FIG. 2 is a schematic diagram illustrating the arrangement state of the LEDs of respective colors according to another example of the LED lighting device of the present invention.

### DESCRIPTION OF EMBODIMENTS

An embodiment according to the present invention will be described below.

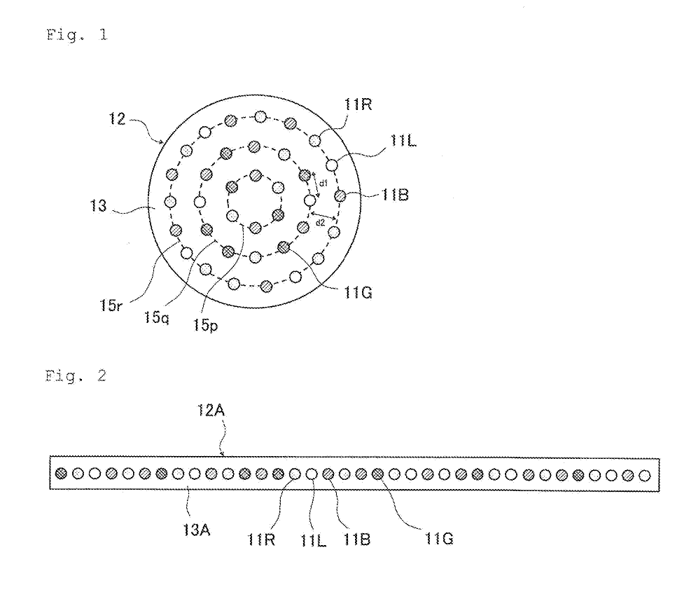

FIG. 1 is a schematic diagram illustrating an arrangement state of LEDs of respective colors according to an example of an LED lighting device of the present invention.

The LED lighting device includes a plurality of red LEDs 11R, a plurality of green LEDs 11G, a plurality of blue LEDs 11B and a plurality of lime LEDs 11L which are concentrically arranged in an arrangement region 13 of generally circular shape on a disc-like substrate 12.

The LED lighting device of FIG. 1 has three virtual concentric circles 15p, 15q and 15r. LEDs adjoining on each of the concentric circles 15p, 15q and 15r are spaced at equal distances. A distance d2 between two adjoining concentric circles, or equivalently, a difference between the radii of the two concentric circles may preferably be greater than a distance d1 between two adjoining LEDs on the concentric circles 15p, 15q and 15r.

In the LED lighting device according to the present invention, LEDs of the same color are connected in series. The LED lighting device includes a control mechanism for performing operation control such as selecting whether to turn on or off the LEDs of each color and changing output thereof.

For example, mixed color light obtained by the LED lighting device according to the present invention is light of which white color is adjusted within a range of 2200 to 6500 K in color temperature, or light of various colors.

The numbers of LEDs of respective colors arranged in the LED lighting device according to the present invention will be described. The number of red LEDs 11R is a (a≧3). The number of green LEDs 11G is b (b≧2). The number of blue LEDs 11B is c (c≧3). The number of lime LEDs 11L is d (d≧1). The numbers of LEDs of respective colors further satisfy the following conditions (1) to (3):

b≦a (1)

b≦c and (2)

0.1(a+c)≦d≦0.28(a+c) (3)

If the condition (3) is not satisfied, i.e., if the number of lime LEDs 11L is smaller than 10% the total number of red and blue LEDs 11R and 11B, the LED lighting device is not able to emit mixed color light in a sufficiently wide range of color temperatures. On the other hand, if the number of lime LEDs 11L exceeds 28% the total number of red and blue LEDs 11R and 11B, the lime-colored light in the emitted mixed color light is so intense that color balance will be upset. This results in poor color reproducibility and failed irradiation of mixed color light of intended color.

In the example of FIG. 1, the numbers of LEDs of respective colors are such that (red LEDs 11R):(green LEDs 11G):(blue LEDs 11B):(lime LEDs 11L) is 12:7:11:6. The total number of LEDs is 36.

In another example, the numbers of LEDs may be such that (red LEDs 11R):(green LEDs 11G):(blue LEDs 11B):(lime LEDs 11L) is 6:4:5:3. The total number of LEDs may be 18.

In yet another example, the numbers of LEDs may be such that (red LEDs 11R):(green LEDs 11G):(blue LEDs 11B):(lime LEDs 11L) is 6:3:7:2. The total number of LEDs may be 18.

In yet another example, the numbers of LEDs may be such that (red LEDs 11R):(green LEDs 11G):(blue LEDs 11B):(lime LEDs 11L) is 3:2:3:1. The total number of LEDs may be 9, which is the minimum unit.

In the LED lighting device according to the present invention, at least one or more of LEDs arranged to adjoin each lime LED 11L is/are any of the red LEDs 11R or any of the blue LEDs 11B. If there are a plurality of LEDs arranged to adjoin each lime LED 11L, all the LEDs may preferably be any of the red LEDs 11R or any of the blue LEDs 11B.

According to the present invention, an LED arranged to adjoin a lime LED refers to one that is arranged closest to the lime LED on the same array. In the LED lighting device according to the example of FIG. 1, such LEDs refer to ones on both sides of each lime LED 11L on the virtual concentric circles 15p, 15q and 15r.

In the LED lighting device according to the example of FIG. 1, at least either one of the LEDs adjoining each lime LED 11L on the concentric circles 15p, 15q and 15r is any of the red LEDs 11R or any of the blue LEDs 11B. Both the one and the other of the LEDs may preferably be any of the red LEDs 11R or any of the blue LEDs 11B.

LEDs arranged in the vicinity of each lime LED 11L on an adjoining concentric circle or circles may also preferably be any of the red LEDs 11R or any of the blue LEDs 11B.

The lime LEDs 11L have a light emission efficiency higher than that of the red LEDs 11R and the blue LEDs 11B. Arranging any of the red LEDs 11R or any of the blue LEDs 11B to adjoin each lime LED 11L thus increases the uniformity of the light intensity in the entire arrangement region 13 of the substrate 12. This results in favorable color mixing of the emitted mixed color light on an irradiated surface.

LEDs arranged to adjoin each green LED 11G may preferably be any of the red LEDs 11R or any of the blue LEDs 11B. In other words, the green LEDs 11G and the lime LEDs 11L may preferably be prevented from being arranged to adjoin each other.

In the LED lighting device according to the example of FIG. 1, at least either one of LEDs adjoining each green LED 11G on the concentric circles 15p, 15q and 15r is any of the red LEDs 11R or any of the blue LEDs 11B. Both the one and the other of the LEDs may preferably be any of the red LEDs 11R or any of the blue LEDs 11B.

LEDs arranged in the vicinity of each green LED 11G on an adjoining concentric circle or circles may also preferably be any of the red LEDs 11R or any of the blue LEDs 11B.

The green LEDs 11G have a light emission efficiency lower than that of the lime LEDs 11L and higher than that of the red LEDs 11R and the blue LEDs 11B. Arranging any of the red LEDs 11R or any of the blue LEDs 11B to adjoin each green LED 11G thus increases the uniformity of the light intensity in the entire arrangement region 13 of the substrate 12. This results in even more favorable color mixing of the emitted mixed color light on the irradiated surface.

The red LEDs 11R emit light having a peak wavelength within a range of 620 to 645 nm. The power of the red LEDs 11R is 1 W.

The green LEDs 11G emit light having a peak wavelength within a range of 520 to 540 nm. The power of the green LEDs 11G is 1.71 W.

The blue LEDs 11B emit light having a peak wavelength within a range of 460 to 480 nm. The power of the blue LEDs 11B is 1.6 W.

The lime LEDs 11L emit light having a peak wavelength within a range of 566 to 569 nm. The power of the lime LEDs 11L is 2 W.

An example of arrangement of the LEDs in the arrangement region 13 of the substrate 12 of the foregoing LED lighting device will be described. The substrate 12 has a diameter of 227 mm. The distance d1 between two adjoining LEDs on the concentric circles 15p, 15q and 15r is 30.6 mm. The distance d2 between two adjoining concentric circles is 29.5 mm.

In the foregoing LED lighting device, the control mechanism selects whether to turn on or off the LEDs of each color and controls the power applied to the LEDs of each color to control brightness of the lit LEDs. The LED lighting device thereby emits intended mixed color light such as white color-adjusted light and color light.

The LED lighting device described above includes respective relatively-specified numbers of red LEDs 11R, blue LEDs 11B, green LEDs 11G and lime LEDs 11L. Mixed color light in a wide range of color temperatures can thus be emitted by simply performing operation control on the LEDs of each color. In the LED lighting device, at least one or more of LEDs arranged to adjoin each lime LED 11L is/are any of the red LEDs 11R or any of the blue LEDs 11B.

Since the lime LEDs 11L have a light emission efficiency higher than that of the red LEDs 11R and the blue LEDs 11B, such an arrangement of LEDs increases the uniformity of the light intensity in the entire arrangement region 13 of the substrate 12. This results in favorable color mixing of the emitted mixed color light on the irradiated surface.

The embodiment according to the present invention has been described above. However, the present invention is not limited to the foregoing embodiment, and various modifications maybe made thereto.

For example, the LED lighting device according to the present invention is not limited to the configuration including a disc-like substrate and in which the LEDs are arranged in a generally circular arrangement region. The LEDs may be arranged in a rectangular arrangement region. As illustrated in FIG. 2, the LEDs maybe arranged at equal distances in a linear arrangement region 13A of a rectangular substrate 12A.

Examples of experiments conducted to confirm the operation and effect of the present invention will be described below.

### EXPERIMENT EXAMPLES 1 to 3

An LED lighting device [1] including 36 color LEDs was fabricated on the basis of the configuration of FIG. 1.

In the LED lighting device [1], the distance d1 between two adjoining LEDs on a concentric circle was 30.6 mm. The distance d2 between adjoining concentric circles was 29.5 mm.

Using the LED lighting device [1], the red LEDs, the green LEDs, the blue LEDs and the lime LEDs were lit with applied power illustrated in Table 1. The applied power of the LEDs of each color, listed in Table 1, is the total power applied to the LEDs of that color. The color temperature of the emitted mixed color light and the illuminance on the irradiated surface were measured. The efficiency was calculated as well.

Through visual observation of the color mixing of the obtained mixed color light on the irradiated surface, the mixed color light in all of experiment examples 1 to 3 was confirmed to provide favorable color mixing without nonuniformity.

TABLE 1

| | | | | | MIXED COLOR LIGHT | | | |
|---|---|---|---|---|---|---|---|---|
| | APPLIED POWER [W] | | | | | COLOR | | |
| | RED | GREEN | BLUE | LIME | | TEMPERATURE | ILLUMINANCE | EFFICIENCY |
| | LED | LED | LED | LED | NAME | [K] | [lx] | [lm/W] |
| EXPERIMENT | 5.4 | 4.5 | 2.7 | 4.5 | LIGHT BULB | 3132 | 928 | 76 |
| EXAMPLE1 | | | | | COLOR | | | |
| EXPERIMENT | 5.4 | 7.2 | 3.3 | 4.5 | WHITE | 4090 | 1231 | 74 |
| EXAMPLE2 | | | | | | | | |
| EXPERIMENT | 5.6 | 5.07 | 5.2 | 3.9 | NATURAL | 5159 | 975 | 71 |
| EXAMPLE3 | | | | | WHITE | | | |

### REFERENCE SIGNS LIST

11R red LED
11G green LED
11B blue LED
11L lime LED
12, 12A substrate
13, 13A arrangement region
15p, 15q, 15r concentric circle

1. An LED lighting device comprising
a substrate,
a (a≧3) red LEDs, b (b≧2) green LEDs, c (c≧3) blue LEDs and d (d≧1) lime LED (s) that are arranged in an arrangement region on the substrate, and
a control mechanism that performs operation control on the LEDs of each color, wherein
following conditions (1) to (3):
b≦a (1)
b≦c and (2)
0.1(a+c)≦d≦0.28(a+c) (3)
are satisfied, and
at least one or more of the LEDs arranged to adjoin each lime LED is/are any of the red LEDs or any of the blue LEDs.

2. The LED lighting device according to claim 1, wherein
the red LEDs emit light having a peak wavelength within a range of 620 to 645 nm,
the green LEDs emit light having a peak wavelength within a range of 520 to 540 nm,
the blue LEDs emit light having a peak wavelength within a range of 460 to 480 nm, and
the lime LED(s) emits/emit light having a peak wavelength within a range of 566 to 569 nm.

3. The LED lighting device according to claim 1, wherein an LED arranged to adjoin each green LED is any of the red LEDs or any of the blue LEDs.

4. The LED lighting device according to claim 2, wherein an LED arranged to adjoin each green LED is any of the red LEDs or any of the blue LEDs.
